(19) United States
(12) Patent Application Publication
(10) Pub. No.: US 2010/0138251 A1
(43) Pub. Date: Jun. 3, 2010

(54) Governing The Design Of Services In A Service Oriented Architecture

(75) Inventors: William A. Brown, Raleigh, NC (US); Kerrie L. Holley, Montara, CA (US); Garrison A. Moore, Uxbridge (CA); William J. Tegan, Oakland, CA (US)

Correspondence Address: BIGGERS & OHANIAN (END), C/O BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 12/326,390

(22) Filed: Dec. 2, 2008

(51) Int. Cl. G06F 9/44

(52) U.S. Cl. 705/7

(57) ABSTRACT

Governing the design of services in an SOA including creating a high level service design from the service model; if the high level service design and the estimated cost of the SOA complies with predetermined service design verification policies, creating a low level service design from the high level service design; and if the low level service design and the estimated updated cost of the SOA complies with predetermined low-level service design verification policies, incorporating the low level service design in a design specification for the SOA.

### BACKGROUND OF THE INVENTION

1. Field of the Invention

The field of the invention is data processing, or, more specifically, methods and systems for governing the design of services in a Service Oriented Architecture (‘SOA’).

2. Description of Related Art

Service Oriented Architecture (‘SOA’) is an architectural style that guides all aspects of creating and using business processes, packaged as services, throughout their lifecycle, as well as defining and provisioning the IT (‘information technology’) infrastructure that allows different applications to exchange data and participate in business processes loosely coupled from the operating systems and programming languages underlying those applications. SOA represents a model in which functionality is decomposed into distinct units (services), which can be distributed over a network and can be combined together and reused to create business applications. These services communicate with each other by passing data from one service to another, or by coordinating an activity between two or more services. The concepts of Service Oriented Architecture are often seen as built upon, and the evolution of, the older concepts of distributed computing and modular programming.

Although services and a business's SOA architecture are often strictly defined, governance of an SOA, implementation of an SOA, operation of an SOA, and management of an SOA is often not defined. A defined model of governance, however, may increase effectiveness and efficiency in implementing, operating, and managing a business's SOA, thereby providing savings to the business.

### SUMMARY OF THE INVENTION

Governing the design of services in an SOA including receiving a service model, the service model having preliminary design patterns that include preliminary service components allocated to preliminary service layers of the SOA service architecture; creating a high level service design from the service model; estimating the cost of the SOA in dependence upon the high level service design; determining, during an architectural inspection, whether the high level service design and the estimated cost of the SOA complies with predetermined high-level service design verification policies; if the high level service design and the estimated cost of the SOA complies with predetermined service design verification policies, creating a low level service design from the high level service design; estimating an updated cost of the SOA in dependence upon the low level service design; determining, during a follow-up architectural inspection, whether the low level service design and the estimated updated cost of the SOA complies with predetermined low-level service design verification policies; and if the low level service design and the estimated updated cost of the SOA complies with predetermined low-level service design verification policies, incorporating the low level service design in a design specification for the SOA.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a system for governing a Service Oriented Architecture (‘SOA’) according to embodiments of the present invention.

FIG. 2 sets forth a flow chart illustrating an exemplary method for governing an SOA according to embodiments of the present invention.

FIG. 3 sets forth a flow chart illustrating a further exemplary method for governing an SOA according to embodiments of the present invention.

FIG. 4 sets forth a flow chart illustrating a further exemplary method for governing an SOA according to embodiments of the present invention.

FIG. 5 sets forth a flow chart illustrating a further exemplary method for governing an SOA according to embodiments of the present invention.

FIG. 6 sets forth a flow chart illustrating a further exemplary method for governing an SOA according to embodiments of the present invention.

FIG. 7 sets forth a flow chart illustrating an exemplary method of governing realizing services in a Service Oriented Architecture (‘SOA’).

FIG. 8 sets forth a flow chart illustrating an exemplary method of allocating service components to service layers in the preliminary SOA service architecture.

FIG. 9 sets forth a flow chart illustrating an exemplary method for determining whether the service components and the services allocated to the service components are technically feasible in the layers of the preliminary SOA architecture to which they are allocated.

FIG. 10 sets forth a flow chart illustrating an exemplary method of governing the design of services in a Service Oriented Architecture (‘SOA’).

FIG. 11 sets forth a flow chart illustrating exemplary methods of creating a high level service design from the service model and creating a low level service design from the high level service design.

### DETAILED DESCRIPTION OF EXEMPLARY EMBODIMENTS

### Governing a Service Oriented Architecture (‘SOA’)

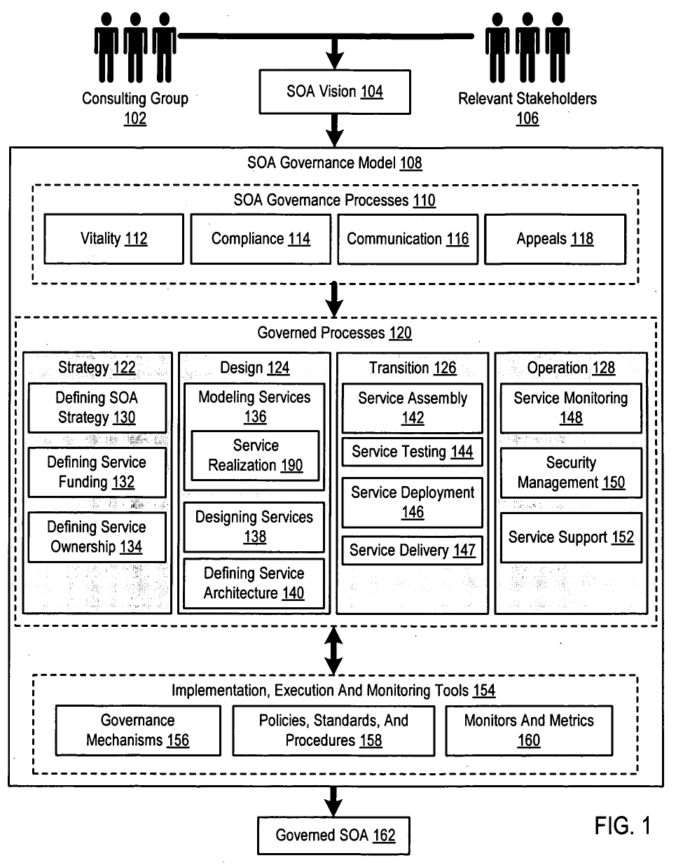

Exemplary methods and systems for aspects of governing an SOA in accordance with embodiments of the present invention are described with reference to the accompanying drawings, beginning with FIG. 1. FIG. 1 sets forth a block diagram of a system for governing a Service Oriented Architecture (‘SOA’) according to embodiments of the present invention. SOA is an architectural style that guides all aspects of creating and using business processes, packaged as services, throughout their lifecycle, as well as defining and provisioning the information technology (‘IT’) infrastructure that allows different applications to exchange data and participate in business processes loosely coupled from the operating systems and programming languages underlying those applications. SOA represents a model in which functionality is decomposed into distinct units, called services, which can be distributed over a network, can be combined together, and reused to create business applications. These services communicate with each other by passing data from one service to another, or by coordinating an activity between two or more services. The concepts of Service Oriented Architecture are often seen as built upon, and the evolution of, the older concepts of distributed computing and modular programming.

The system of FIG. 1 includes an SOA governance model (108) that provides parameters used in governing a business's SOA, that is, a governed SOA (162). An SOA governance model may be established through use of a consulting group (102), using software tools and business artifacts, and relevant stakeholders (106) of a business. A consulting group may include one or more individuals that guide members of a business in establishing and implementing an SOA governance model. Such individuals typically are not members of the business. Consulting groups often work closely with relevant stakeholders of the business in establishing and implementing an SOA governance model.

A relevant stakeholder (106) of a business is an individual or party that affects, or can be affected by, a business's actions. “Relevant stakeholders,” as the term is used in the specification, refers to stakeholders which are most directly affected by a business's actions with respect to SOA and often have decision making authority with regard to one or more aspects of the SOA governance model. Although only consulting groups and relevant stakeholders are described here with respect to implementing and operating a governance model in accordance with embodiments of the present invention, readers of skill in the art will immediately recognize that many other individuals or group of individuals associated with a business may take part in implementing and operating some or more aspects such a governance model and each such individual or group of individuals and their actions are also well within the scope of the present invention.

The exemplary SOA governance model (108) of FIG. 1 may be implemented and operated according to an SOA vision (104) that may be defined by the consulting (102) and the relevant stakeholders (106) of the business. That is, a consulting group may be used to guide relevant stakeholders through a process of identifying an SOA vision which may be used to define not only primary boundaries of the business's SOA, but also a governance model for the SOA. An SOA vision (104) is a general and broad definition of an SOA strategy to be accomplished through use of an SOA. An example of such an SOA strategy which may be accomplished through use of an SOA, is to reduce redundancy in the use of different software applications that provide similar functionality to different organizational entities of the business. Consider, for example, that a retail sales department and an online sales department use different software applications to provide the similar function of receiving and processing customer orders. An SOA vision may outline business goals of the SOA that may be implemented that reduce such redundancy by providing a single service of customer order receipt and processing to both the retail sales department and the online sales department of the business.

As mentioned above, an SOA governance model (108) provides parameters used in governing a business's governed SOA (162). The exemplary SOA governance model (108) of FIG. 1, for example, includes several SOA governance processes (110). An SOA governance process (110) is a processes that when executed governs one or more governed SOA processes (110), the governed processes typically used in implementing, operating, maintaining, and managing an SOA for a business. That is, the governance processes, when executed, effect governance of the typical implementation, operation, maintenance, and management of an SOA for a business.

The exemplary SOA governance model (108) of FIG. 1 the SOA includes a vitality (112) governance processes, a compliance (114) governance process, a communication (116) governance processes, and an appeals (118) governance process. The vitality (112) governance process maintains the applicability of the SOA governance model. The vitality process ensures that the governance model is current, reflecting current business and information technology and strategy, and also refines other governance processes and governance mechanisms to ensure continued usage and relevance of the governance model.

The compliance (114) governance process governs the review and approval processes used in implementing and managing services within an SOA. The governance processes includes providing criteria defined in the establishment of an SOA governance model to guide such review and approval processes. Such criteria may include a business's principles, standards, defined business roles, and responsibilities associated with those defined business roles.

The communication (116) governance process governs communication of SOA vision, SOA plans, and the SOA governance model to members of the business for educating such members. The communication governance process ensures that governance is acknowledged and understood throughout a business and also provides, to members of the business, environments and tools for easy access and use of information describing an SOA governance model.

The appeals (118) governance process enables members of a business to appeal SOA decisions. This appeals governance process therefore also provides exceptions to business policies, information technology policies, and other criteria that must typically be met within SOA decision-making processes.

As mentioned above, each of the governance processes when executed governs one or more governed processes. A governed process is a process used in implementing, operating, maintaining, and managing an SOA for a business. The exemplary SOA governance model (108) of FIG. 1 includes categories of governed processes (122, 124, 126, 128). Each category represents an area of SOA implementation, operation, maintenance, and management carried out by the governed processes included in the category.

The categories of governed processes in the example of FIG. 1 include strategy (122), design (124), transition (126), and operation (128). Processes included in the category of strategy (122) generally carry out an initial planning of service implementation. Examples of governed processes included in the category of strategy include a process for defining SOA strategy (130), defining service funding (132), and defining service ownership (134).

Processes included in the category of design (124) generally carry out identification and definition of particular services for an SOA. Examples of governed processes included in the category of design include a process for modeling services (136), designing services (138), and defining service architecture (140). In the example of FIG. 1 the governed process of modeling services (136) includes the process of service realization (190). Governing realizing services in a Service Oriented Architecture (‘SOA’) according to embodiments of the present invention includes receiving a preliminary service model and a preliminary SOA service architecture; allocating services in the preliminary service model (704) to service components; allocating service components to service layers in the preliminary SOA service architecture; determining whether the service components and the services allocated to the service components are technically feasible in the layers of the preliminary SOA architecture to which they are allocated; if the service components and the services allocated to the service components are technically feasible in the layers of the preliminary SOA architecture to which they are allocated, updating the service model; determining whether the technically feasible updated service model meets predetermined SOA compliance requirements; if the updated service model meets predetermined SOA compliance requirements, communicating the SOA compliant updated service model to relevant stakeholders in the SOA.

Governing the design of services in an SOA according to embodiments of the present invention includes receiving a service model, the service model having preliminary design patterns that include preliminary service components allocated to preliminary service layers of the SOA service architecture; creating a high level service design from the service model; estimating the cost of the SOA in dependence upon the high level service design; determining, during an architectural inspection, whether the high level service design and the estimated cost of the SOA complies with predetermined high-level service design verification policies; if the high level service design and the estimated cost of the SOA complies with predetermined service design verification policies, creating a low level service design from the high level service design; estimating an updated cost of the SOA in dependence upon the low level service design; determining, during a follow-up architectural inspection, whether the low level service design and the estimated updated cost of the SOA complies with predetermined low-level service design verification policies; and if the low level service design and the estimated updated cost of the SOA complies with predetermined low-level service design verification policies, incorporating the low level service design in a design specification for the SOA.

Processes included in the category of transition (126) generally carry out implementation of services in an SOA. Examples of governed processes included in the category of transition (126) include a process for service assembly (142), service testing (144), service deployment (146), and service delivery (147). Processes included in the category of operation (128) generally carry out management and monitoring of services operating within an SOA. Examples of governed processes included in the category of operation (128) include a process for service monitoring (148), security management (150), and service support (152).

The SOA governance processes (110) of FIG. 1 are executed and implemented by one or more implementation, execution and monitoring tools (154). Such implementation tools may include governance mechanisms (156). Governance mechanisms (156) may include one or more individuals, organizational entities, and business infrastructure to carry out governance according to the governance model (108). Such individuals may include relevant stakeholders, committees, or boards responsible for carrying out such governance. Organizational entities may include, for example, a board of directors, management groups, departments within a business, and the like. Business infrastructure may include available human labor, software applications, database management systems, computer technology, funding, and other types of business infrastructure as will occur to those of skill in the art. Different governance mechanisms (156) may be responsible for carrying out governance of different categories (122,124,126,128) of governed processes (120).

Other exemplary implementation and execution tools (154) in the exemplary system of FIG. 1 include policies, standards, and procedures (158). Policies, standards, and procedures (158) are embodiments of a business's overall business principles and are typically used in guiding decision-making in many of the governed processes (120). That is, policies, standards, and procedures (158) are compliance requirements, defined according to the business's SOA.

Other exemplary implementation, execution, and monitoring tools (154) in the exemplary system of FIG. 1 include monitors and metrics (160). Monitors are typically used to gather data describing performance of governed processes (120) and SOA governance processes (110). The data describing performance of governed processes and SOA governance processes may be compared to specified metrics in order to determine whether the performance of the governed processes and SOA governance processes is weak or strong. The metrics may also be used to identify particular steps of governed processes (120) and SOA governance processes (110) are ripe for improvement. As such monitors and metrics may be used to increase the efficiency and overall effectiveness of not only the governed processes typically used in implementing, operating, maintaining, and managing an SOA (162), but may also be used to increase the efficiency and overall effectiveness of the SOA governance processes (110) that govern such governed processes (120).

The arrangement of governance processes, governed processes, implementation and execution tools making up the exemplary system illustrated in FIG. 1 are for explanation, not for limitation. Systems useful according to various embodiments of the present invention may include additional computer technology, software applications, servers, routers, devices, architectures, organizational entities, and business members not shown in FIG. 1, as will occur to those of skill in the art. Networks in such systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms.

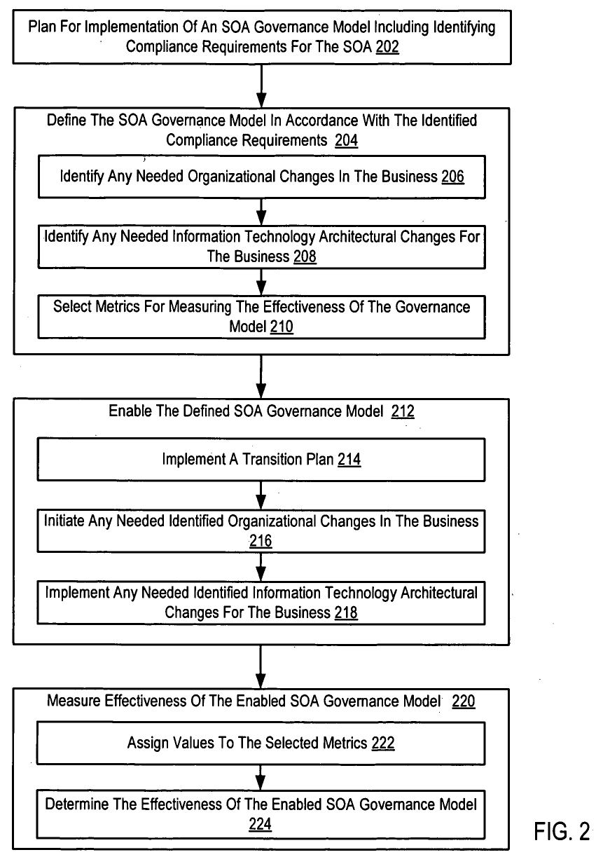

For further explanation, FIG. 2 sets forth a flow chart illustrating an exemplary method for governing an SOA according to embodiments of the present invention. The method of FIG. 2 includes planning (202) for implementation of an SOA governance model for governing a business's SOA. An SOA governance model provides parameters used in governing a business's SOA. In the method of FIG. 2, planning (202) for implementation of an SOA governance model for governing a business's SOA includes identifying compliance requirements for the SOA. Compliance requirements typically include criteria, principles, standards, business principles, and information technology principles of a business with which a businesses SOA, and therefore governance of the SOA, must typically comply. In some cases, however, exceptions to the compliance requirements may be made in accordance with governance processes defined within the SOA governance model. Planning (202) for implementation of an SOA governance model for governing a business's SOA may be carried out by one or more business members, one or more governance software applications, web servers, spreadsheets, databases, computers, networks, aggregations of software and hardware, and other tools and artifacts as will occur to those of skill in the art.

The method of FIG. 2 also includes defining (204) the SOA governance model in accordance with the identified compliance requirements. In the method of FIG. 2 defining (204) the SOA governance model in accordance with the identified compliance requirements includes identifying (206) any needed organizational changes in the business, identifying (208) any needed information technology architectural changes for the business, and selecting (210) metrics for measuring the effectiveness of the governance model. Organizational changes in the business may include restructuring of business departments, reorganization of a board of directors, hiring new employees, or removing current employees. Information Technology (‘IT’) architectural changes for a business may include modifying hardware infrastructure such as adding or removing a network or a data center. IT architectural changes may also include modifying software infrastructure for the business such as unifying the currently installed operating system on each of the business's computers, updating database management software, installing one or more software applications, and so on. Defining (204) the SOA governance model in accordance with the identified compliance requirements may be carried out by one or more business members, one or more governance software applications, web servers, spreadsheets, databases, computers, networks, aggregations of software and hardware, and other tools as will occur to those of skill in the art.

The method of FIG. 2 also includes enabling (212) the defined SOA governance model. In the method of FIG. 2, enabling (212) the defined SOA governance model includes implementing (214) a transition plan, initiating (216) any needed identified organizational changes in the business, and implementing (218) any needed identified information technology architectural changes for the business. A transition plan is a plan describing the execution of a modification in a business's SOA or in the business's SOA governance. Enabling (212) the defined SOA governance model may be carried out by one or more business members, one or more governance software applications, web servers, spreadsheets, databases, computers, networks, aggregations of software and hardware, and other tools as will occur to those of skill in the art.

The method of FIG. 2 also includes measuring (220) effectiveness of the enabled SOA governance model. In the example of FIG. 2 measuring (220) effectiveness of the enabled SOA governance model includes assigning (222) values to the selected metrics and determining (224), in dependence upon the values of the selected metrics, the effectiveness of the enabled SOA governance model. Measuring (220) effectiveness of the enabled SOA governance model may be carried out by one or more business members, one or more governance software applications, web servers, spreadsheets, databases, computers, networks, aggregations of software and hardware, and other tools as will occur to those of skill in the art.

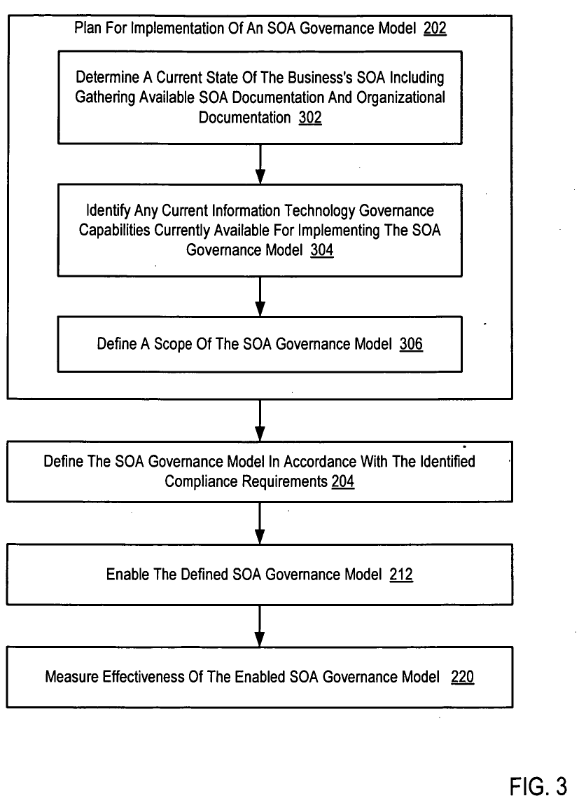

For further explanation, FIG. 3 sets forth a flow chart illustrating a further exemplary method for governing an SOA according to embodiments of the present invention. The method of FIG. 3 is similar to the method of FIG. 2 in that the method of FIG. 3 also includes planning (202) for implementation of an SOA governance model for governing a business's SOA including identifying compliance requirements for the SOA, defining (204) the SOA governance model in accordance with the identified compliance requirements, enabling (212) the defined SOA governance model, and measuring (220) effectiveness of the enabled SOA governance model.

The method of FIG. 3 differs form the method of FIG. 2, however, in that in the method of FIG. 3, planning (202) for the implementation of an SOA governance model for governing business's SOA includes determining (302) a current state of the business's SOA including gathering available SOA documentation and organizational documentation, identifying (304) any current information technology governance capabilities currently available for implementing the SOA governance model, and defining (306) a scope of the SOA governance model.

In the method of FIG. 3, determining (302) a current state of the business's SOA including gathering available SOA documentation and organizational documentation may be carried out by identifying business principles of the business for use in the SOA governance model, identifying information technology principles of the business for use in the SOA governance model, and determining the effectiveness of current information technology governance procedures in governing current business principles and current information technology principles. A consulting group and relevant stakeholders may use software applications, artifacts, computer hardware, and other devices to carry out such identification and determination.

In the method of FIG. 3, identifying (304) any current information technology governance capabilities currently available for implementing the SOA governance model may be carried out by determining, in dependence upon a Control Objectives for Information and related Technology (‘COBIT’) framework, existing governance capabilities of the business; determining, in dependence upon a Service Integration Maturity Model (‘SIMM’), existing governance capabilities of the business; and conducting a change readiness survey to identify existing information technology governance capabilities. COBIT is a set of “best practices” or a framework for information technology management created by the Information Systems Audit and Control Association (‘ISACA’), and the IT Governance Institute (‘ITGI’). COBIT provides managers, auditors, and IT user with a set of generally accepted measures, indicators, and processes to assist the managers, auditors, and IT users in maximizing the benefits derived through the use of information technology and developing appropriate IT governance and control. SIMM is a model used to increase maturity of service integration and SOA adoption through all areas of a business. A change readiness survey is a survey used to identify, evaluate, and monitor, the readiness of the business to accept and adopt changes required by SOA governance.

In the method of FIG. 3 defining (306) a scope of the SOA governance model may be carried out by identifying processes to be governed according to the business's SOA governance model, and identifying prospective governance mechanisms. Governance mechanisms are referred to here as “prospective” because the identified governance mechanisms may or may not be used when the governance model is implemented. Each prospective governance mechanism, however, is capable of administering SOA governance processes that govern the identified governed processes. As mentioned above, governance mechanisms may include one or more individuals, organizational entities, and business or technology infrastructure to carry out governance according to the governance model.

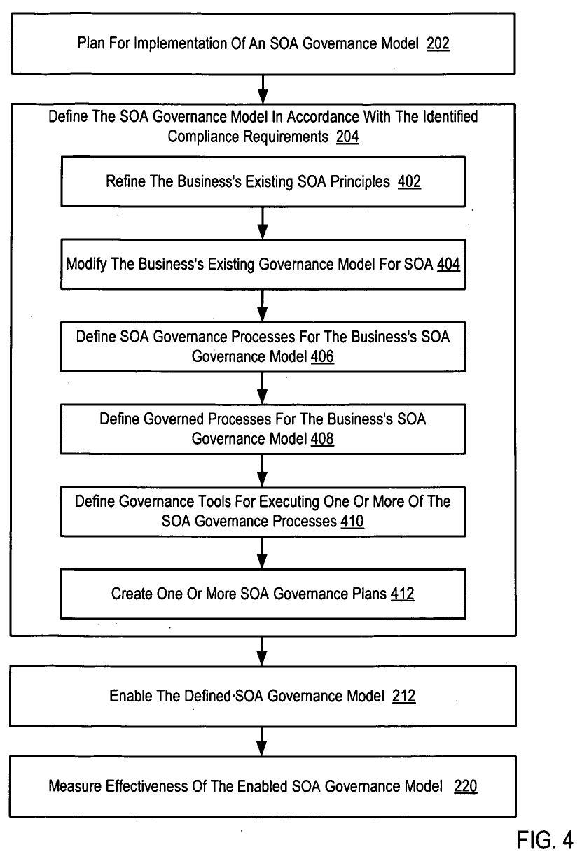

For further explanation, FIG. 4 sets forth a flow chart illustrating a further exemplary method for governing an SOA according to embodiments of the present invention. The method of FIG. 4 is similar to the method of FIG. 2 in that the method of FIG. 4 also includes planning (202) for implementation of an SOA governance model for governing a business's SOA including identifying compliance requirements for the SOA, defining (204) the SOA governance model in accordance with the identified compliance requirements, enabling (212) the defined SOA governance model, and measuring (220) effectiveness of the enabled SOA governance model.

The method of FIG. 4 differs form the method of FIG. 2, however, in that in the method of FIG. 4 defining (204) the SOA governance model in accordance with the identified compliance requirements includes refining (402) the business's existing SOA principles; modifying (404) the business's existing governance model for SOA; defining (406) SOA governance processes for the business's SOA governance model, the SOA governance processes comprising processes that govern a set of governed processes in a business's SOA; defining (408) governed processes for the business's SOA governance model, each governed process capable of governing a portion of a business's SOA, each governed processes governed by one or more SOA governance processes; defining (410) governance tools for executing one or more of the SOA governance processes; and creating (412) one or more SOA governance plans.

In the method of FIG. 4, refining (402) the business's existing SOA principles may be carried out by updating the business's existing SOA business principles according to a business's SOA vision and updating the business's existing SOA information technology principles, policies, or standards according to the business's SOA vision. In some cases, a business may have existing SOA business principles prior to implementation of SOA governance. In other cases, the business's SOA is implemented in conjunction with the SOA governance model. For the former, existing SOA business principles may be modified according to the business's currently identified SOA vision which may vary when an SOA governance model is implemented. Also in some cases, a business may have existing SOA information technology principles, policies, and standards prior to the implementation of an SOA governance model. These existing SOA information technology principles, policies, and standards may also be modified in accordance with the business's currently identified SOA vision.

In the method of FIG. 4, modifying (404) the business's existing governance model for SOA may be carried out by redefining processes used in the business's existing governance model according to the business's SOA vision. In some cases a business may be operating within an existing governance model that governs aspects of the business other than SOA, such as for example, and existing IT governance model. Such an existing governance model may be modified for SOA by redefining the existing governance model according to the business's SOA vision and strategy.

In the method of FIG. 4, defining (408) governed processes for the business's SOA governance model may be carried out by selecting, from a preconfigured set of prospective governed processes in dependence upon a business's SOA vision, one or more prospective governed processes to be used as governed processes in the business's SOA governance model; developing, in dependence upon the business's SOA vision, one or more additional governed processes to be used as governed process in the business's SOA governance model; defining, for each selected and developed governed process, a policy for managing the governed process; and defining, for each governed process in dependence upon the governed processes defined policy, metrics for measuring the effectiveness of the governed process. In some cases a consulting group may provide a preconfigured set of prospective governed processes to relevant stakeholders to enable the relevant stakeholders to begin defining processes to be governed by an SOA governance model. In other cases, a consulting group and relevant stakeholders may create, define, and implement new processes to be governed by the business's SOA governance model. The policies defined for each of the governed processes typically identify parameters, based on the business principles, SOA principles, and IT principles, with which each governed process must comply.

In the method of FIG. 4, defining (410) governance tools for executing one or more of the SOA governance processes may be carried out by: identifying one or more of the business's current governance tools currently employed by the business; modifying one or more of the identified governance tools for use as governance tools for executing the business's SOA governance model; establishing one or more of the identified governance tools as governance tools for executing one or more SOA governance processes; establishing one or more additional governance tools for use as governance tools for executing one or more SOA governance processes, the additional governance tools not currently employed in the business's existing governance model; and defining metrics for measuring the effectiveness of each of the governance tools for executing one or more SOA governance processes. A governance tool includes any available business asset used in carrying out a governance process. Such available business assets may include one or more business members, organizational entities, computer technology, information technology infrastructure, artifacts, and other available assets as will occur to those of skill in the art.

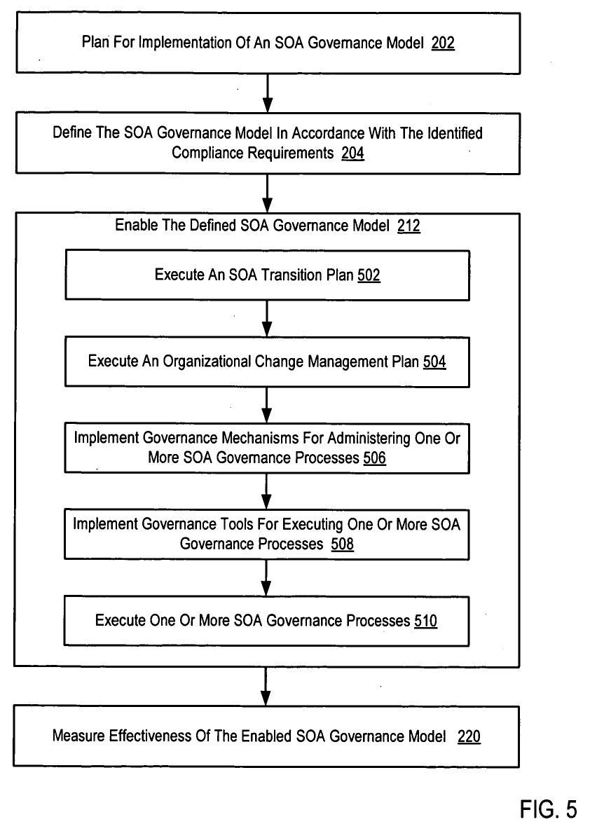

In the method of FIG. 4, creating (412) one or more SOA governance plans may be carried out by creating an SOA governance support plan; creating an organizational change management plan including establishing one or more metrics for measuring effectiveness of an organization defined according to an organization change management plan; and creating an SOA transition plan. An SOA governance support plan may include a communication plan that defines methods of communicating SOA vision, standards, principles, and the like to members of a business. An SOA governance support plan may also include a mentoring plan that outlines methods for mentoring users of services in the SOA. An SOA governance support plan may also include an education and training plan that describes the training and education made available by a business for users and developers of service in the business's SOA. For further explanation, FIG. 5 sets forth a flow chart illustrating a further exemplary method for governing an SOA according to embodiments of the present invention. The method of FIG. 5 is similar to the method of FIG. 2 in that the method of FIG. 5 also includes planning (202) for implementation of an SOA governance model for governing a business's SOA including identifying compliance requirements for the SOA, defining (204) the SOA governance model in accordance with the identified compliance requirements, enabling (212) the defined SOA governance model, and measuring (220) effectiveness of the enabled SOA governance model.

The method of FIG. 5 differs from the method of FIG. 2, however, in that in the method of FIG. 5, enabling (212) the defined SOA governance model includes executing (502) an SOA transition plan; executing (504) an organizational change management plan; implementing (506) governance mechanisms for administering one or more SOA governance processes that govern one or more governed processes implementing (508) governance tools for executing one or more SOA governance processes; and executing (510), by the governance mechanisms through use of governance tools, one or more SOA governance processes. As mentioned above, an SOA transition plan is a plan describing the execution of a modification in a business's SOA or in the business's SOA governance.

An organizational change management plan is a plan describing the steps of managing an organizational change in the business where such an organizational change aids in the governing of a business's SOA. Executing an organizational change management plan may be carried out by one or more members of the business having responsibility for carrying out such a change in organizational structure. Executing an organizational change management plan may include allocating resources, hiring new employees, restructuring existing business organizations, defining new responsibilities for current employees, and so on as will occur to readers of skill in the art.

Governance tools may include any available business asset used in carrying out a governance process. Governance tools such as IT tools, may be implemented by installing computer hardware such as blade servers, configuring computer hardware including configuring data communications networks, installing software, configuring database systems, installing plug-ins to existing software packages and so on as will occur to readers of skill in the art.

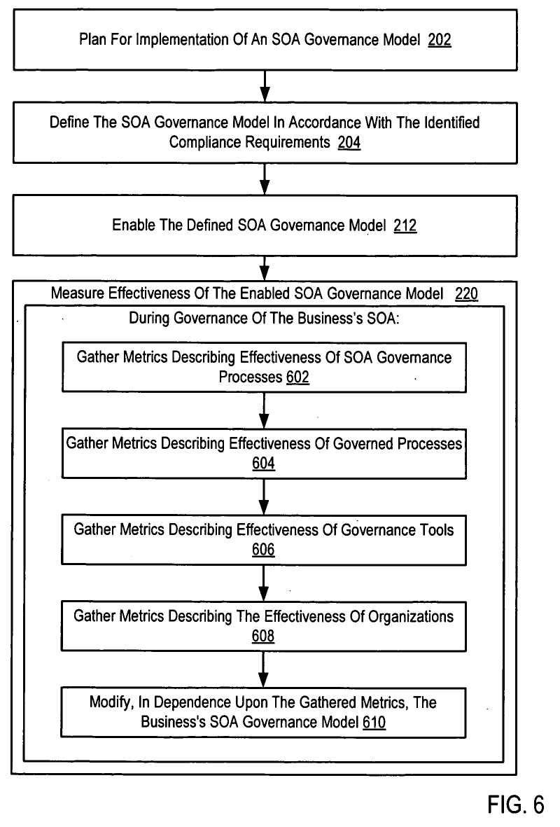

For further explanation, FIG. 6 sets forth a flow chart illustrating a further exemplary method for governing an SOA according to embodiments of the present invention. The method of FIG. 6 is similar to the method of FIG. 2 in that the method of FIG. 6 also includes planning (202) for implementation of an SOA governance model for governing a business's SOA including identifying compliance requirements for the SOA, defining (204) the SOA governance model in accordance with the identified compliance requirements, enabling (212) the defined SOA governance model, and measuring (220) effectiveness of the enabled SOA governance model.

The method of FIG. 6 differs from the method of FIG. 2, however, in that in the method of FIG. 2, measuring (220) effectiveness of the enabled SOA governance model includes gathering (602) metrics describing effectiveness of SOA governance processes; gathering (604) metrics describing effectiveness of governed processes; gathering (606) metrics describing effectiveness of governance tools; gathering (608) metrics describing the effectiveness of organizations defined according to the business's organization change management plan; and modifying (610), in dependence upon the gathered metrics, the business's SOA governance model, all during governance of the business's SOA according to the enabled SOA governance model.

Metrics describing effectiveness may include surveys of business members involved in carrying out governance processes, data recorded by computer systems identifying decision making statistics, such as the amount of time required to make a decision, or the number of parties involved in the decision making process, and so on as will occur to those of skill in the art. Metrics typically describe a level of service. Metrics that measure a service level are compared to a baseline service level, a level of service which a business desires to provide through SOA and SOA governance. Metrics may therefore be used to identify areas of SOA or SOA governance which may be improved to more closely provide the baseline service level of business.

From time to time during governance of the business's SOA, the SOA governance model may be improved. Such improvement is enabled by gathering various metrics, assigning values to those gathered metrics, comparing the assigned values of the gathered metrics to criteria and identifying areas where improvement is needed. Once areas of needed improvement are identified, a consulting group and relevant stakeholders, such as for example, an SOA governance board, may improve the SOA governance model in the areas identified.

### Governing Realizing Services in a Service Oriented Architecture

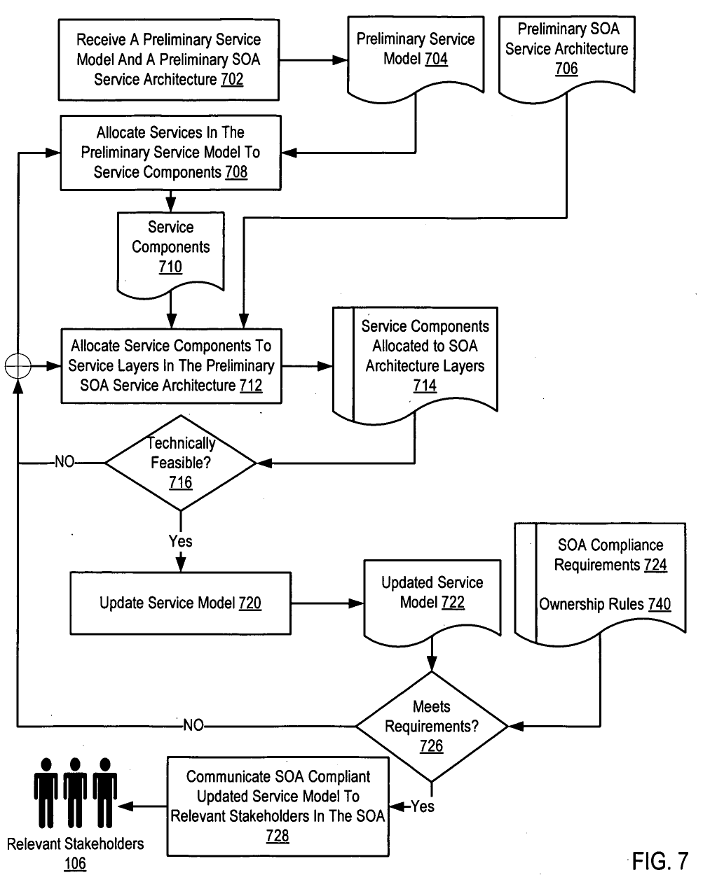

FIG. 7 sets forth a flow chart illustrating an exemplary method of governing realizing services in a Service Oriented Architecture (‘SOA’) according to embodiments of the present invention. The service realization stage of SOA design typically includes mapping high level design to the actual technologies that will realize that high level design. At this stage, architectural and design decisions are made regarding how components will be generally implemented at the design pattern or template level such as what the technologies are available and how they may be used in those design patters, the standards available, how legacy system functionality may be leveraged, the type of adapters that may be required to wrap the legacy systems and others as will occur to those of skill in the art.

The method of FIG. 7 includes receiving (702) a preliminary service model (704) and a preliminary SOA service architecture (706). A preliminary service model (704) is implemented as the documentation of the current and general collection services made preliminarily available to the SOA that typically includes how each currently identified and preliminarily available service is exposed to the SOA, the service's dependencies on other services, the composition of subcomponents of the service, non-functional requirements of the service, the type of messaging used by the service, state management and lifecycle management of the service and other key aspects of the service.

A preliminary SOA service architecture (706) is implemented documentation describing the currently approved business requirements of the SOA, the existing enterprise SOA reference software and hardware architecture, existing preliminary software and hardware architectural decisions, existing architectural standards and guidelines for the SOA, and other project estimates.

Receiving (702) a preliminary service model (704) and a preliminary SOA service architecture (706) may be carried out by one or more business members, one or more business consultants, one or more subject matter experts, one or more governance software applications using web servers, spreadsheets, databases, computers, networks, aggregations of software and hardware, and other tools as will occur to those of skill in the art.

The method of FIG. 7 includes allocating (708) services in the preliminary service model (704) to service components (710). Service components (710) are implemented as a collection of services that may together implement a coarser-grained subsystem. In general, service components are coarser-grained units that encapsulate a number of functional components and may depend on other service components for the fulfillment of their functionality. Service components, as a whole, provide the functionality corresponding to that required by a subsystem. Often service components create an enterprise-scale asset. An implementation of a service component often needs both functional and technical components to provide business functionality. Within the service component, functional components provide application specific logic and technical components provide non-application specific or generic functionality such as authentication, authorization, audit, logging and others as will occur to those of skill in the art. Allocating (708) services in the preliminary service model (704) to service components (710) is carried out by organizing the services and assigning those organized service to component containers to determine the technical functionality required to realize the components and their allocated services. The allocation of the services in the preliminary service model (704) to service components (710) is documented in the overview section of a component model in the preliminary service model.

Allocating (708) services in the preliminary service model (704) to service components (710) may be carried out by one or more business members, one or more business consultants, one or more subject matter experts, one or more governance software applications using web servers, spreadsheets, databases, computers, networks, aggregations of software and hardware, and other tools as will occur to those of skill in the art.

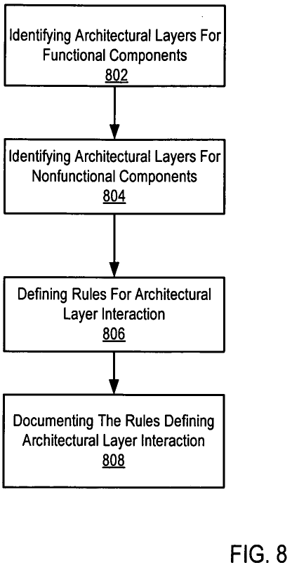

The method of FIG. 7 includes allocating (712) service components (710) to service layers (714) in the preliminary SOA service architecture (706). Service layers (714) in the preliminary SOA service architecture (706) are software layers in the SOA. Such service layers are part of architecture requirements for constructing the SOA. For further explanation, FIG. 8 sets forth a flow chart illustrating an exemplary method of allocating service components to service layers in the preliminary SOA service architecture. The method of FIG. 8 includes identifying (802) architectural layers for functional components and identifying (804) architectural layers for nonfunctional components. Identifying (802) architectural layers for functional components and identifying (804) architectural layers for nonfunctional components. may be carried out by grouping functional components and assigning to the grouped functional components to service layers based on their functionality and grouping non-functional components and assigning the grouped non-functional components to service layers based upon the generality of the non-functional components.

Allocating (712) service components (710) to service layers (714) may be strict or non-strict. Strict layering typically means that components assigned to a particular service layer can only use components in the same service layer or service layers immediately below them. Non-strict layering typically means components assigned to a service layer can use components in the same service layer or any lower service layer. Components are typically restricted from using components in layers residing above them. If components have dependencies on components in higher layers, then it typically becomes difficult to replace the upper layer components without having to change the lower layer components.

The method of FIG. 8 includes defining (806) rules for architectural layer interaction. Defining (806) rules for architectural layer interaction includes determining the communications methods in the SOA and therefore software interfaces used. A change to a lower layer, for example, that does not affect its interface often will require no change to a higher layer. For example, any J2EE™ compliant application server that conforms to the J2EE™ standard typically may be freely substituted without change to application-level software. A change to a higher layer that does not affect what facilities it requires from lower layers typically will not affect any lower layer. In general, changes to a layered software system that affect no interface are confined to a single layer.

The method of FIG. 8 includes documenting (808) the rules defining architectural layer interaction. Documenting (808) the rules defining architectural layer interaction typically includes preliminarily updating the service model with the defined protocols and interfaces for communication among components in different service layers.

Allocating service components to service layers in the preliminary SOA service architecture may be carried out by one or more business members, one or more business consultants, one or more subject matter experts, one or more governance software applications using web servers, spreadsheets, databases, computers, networks, aggregations of software and hardware, and other tools as will occur to those of skill in the art.

Again with reference to FIG. 7: After allocating (712) service components (710) to service layers (714) in the preliminary SOA service architecture (706) the method of FIG. 7 also includes determining (716) whether the service components (710) and the services allocated to the service components are technically feasible in the layers (714) of the preliminary SOA architecture to which they are allocated. Technical feasibility is a preliminary assessment of the allocation of the service components (710) to service layers (714) in the preliminary SOA service architecture (706) from both a technical solutions perspective and a business prospective as those perspectives relate to known existing applications and known existing candidate service providers and known SOA functionality. Technical feasibility is not a technical guarantee that the components are best implemented in those service layers in the ultimately designed SOA. To be technical feasible, a component may be reasonably allocated to a service layer from both a technical solutions perspective and a business prospective such that the allocation may be documented in an updated service model and communicated to relevant stakeholders for later use in designing the SOA.

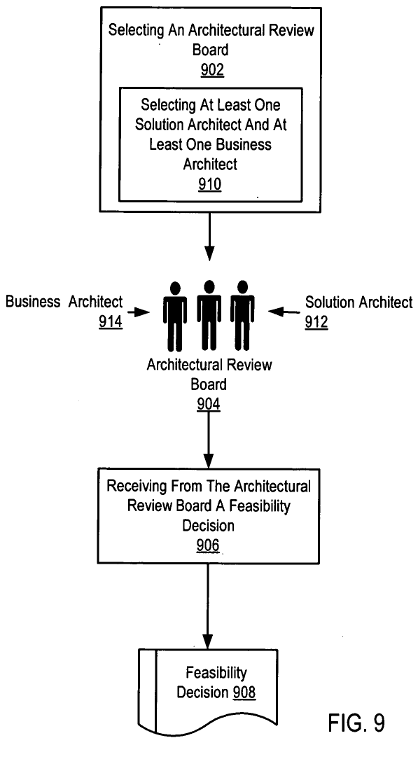

For further explanation, FIG. 9 sets forth a flow chart illustrating an exemplary method for determining whether the service components and the services allocated to the service components are technically feasible in the layers of the preliminary SOA architecture to which they are allocated. The method of FIG. 9 includes selecting (902) an architectural review board (904). An architectural review board is a collection of relevant stakeholders, consultants in a consulting group, appropriate subject matter experts, or other business information sources that are capable of assessing the technical feasibility of the service components allocated into the service layers. The architectural review board of FIG. 9 includes three members. This is, for explanation and not for limitation. In fact, an architectural review board according to embodiments of the present invention may include any number of members including any combination of relevant stakeholders, consultants in a consulting group, appropriate subject matter experts, or other business information sources as will occur to those of skill in the art.

Selecting (902) an architectural review board (904) according to the method of FIG. 9 includes selecting (910) at least one solution architect (912) and at least one business architect (914). A solution architect (912) is a subject matter expert in the field of SOA technical solutions. Such an architect may usefully provide feasibility opinions on technical implementation of an SOA. A business architect (914) is a subject matter expert in business practices or business implementations in an SOA. Such an architect may usefully provide feasibility opinions on the business aspects of an SOA implementation.

The method of FIG. 9 includes receiving (906) from the architectural review board (904) a feasibility decision (908). A feasibility decision is an opinion from the architectural review board as to the feasibility of the allocation of the service components to service layers in the preliminary SOA service architecture. Receiving from the architectural review board a feasibility decision may include receiving a decision that the service components and the services allocated to the service components are not technically feasible in the layers of the preliminary SOA architecture to which they are allocated. If the service components and the services allocated to the service components are not technically feasible in the layers of the preliminary SOA architecture to which they are allocated, governing service realization in an SOA according to embodiments of the present invention typically includes reallocating services in the preliminary service model to service components or reallocating service components to service layers in the preliminary SOA service architecture.

Determining (716) whether the service components (710) and the services allocated to the service components are technically feasible in the layers (714) of the preliminary SOA architecture to which they are allocated may be carried out by one or more business members, one or more business consultants, one or more subject matter experts, one or more governance software applications using web servers, spreadsheets, databases, computers, networks, aggregations of software and hardware, and other tools as will occur to those of skill in the art.

Again with reference to FIG. 7: As mentioned above, FIG. 7, if the service components and the services allocated to the service components are not technically feasible in the layers of the preliminary SOA architecture to which they are allocated the method of FIG. 7 includes two alternatives: reallocating (708) services in the preliminary service model to service components or reallocating (712) service components to service layers in the preliminary SOA service architecture. Reallocating (708) services in the preliminary service model to service components may be carried out by again allocating (708) services in the preliminary service model to service components as described above using the decision of feasibility to change the allocation. Reallocating (712) service components to service layers in the preliminary SOA service architecture may be carried out by again allocating (712) service components to service layers in the preliminary SOA service architecture as described above using the decision of feasibility to change the allocation.

Reallocating (708) services in the preliminary service model to service components or reallocating (712) service components to service layers in the preliminary SOA service architecture may be carried out by one or more business members, one or more business consultants, one or more subject matter experts, one or more governance software applications using web servers, spreadsheets, databases, computers, networks, aggregations of software and hardware, and other tools as will occur to those of skill in the art.

If the service components and the services allocated to the service components are technically feasible in the layers of the preliminary SOA architecture to which they are allocated, the method of FIG. 7 includes updating (710) the service model. Updating (710) the service model further comprises documenting the allocation of services, components and service layers such for later use in developing the SOA. The updated service model may also include other information such as standards available and used in the components allocated to service layers, how legacy system functionality may be leveraged using the components allocated to particular service layers, the type of adapters that may be required to wrap the legacy systems of components allocated to service layers and other information as will occur to those of skill in the art

Updating (710) the service model may be carried out by one or more business members, one or more business consultants, one or more subject matter experts, one or more governance software applications using web servers, spreadsheets, databases, computers, networks, aggregations of software and hardware, and other tools as will occur to those of skill in the art.

The method of FIG. 7 includes determining (726) whether the technically feasible updated service model (722) meets predetermined SOA compliance requirements (724). Predetermined SOA compliance requirements (724) include additional requirements for implementation of the SOA. It is not uncommon for technically feasible component allocations to be impractical to implement. One example of such an impractical implementation is for components to include service owners that are incompatible with either other services in the component of with the technical aspects such as communication standards of the service layer in which they are allocated. In the example of FIG. 7, determining whether the updated service model meets predetermined SOA compliance requirements includes determining whether the technically feasible updated service model complies with SOA service ownership rules. SOA ownership rules are rules defining whether the services allocated to a component or allocated to a component allocated to a particular service layer are incompatible due to the owner of that service. The SOA ownership rules of FIG. 7 of the example of FIG. 7 is for explanation and not for limitation. In fact, many SOA compliance requirements exist and all such SOA compliance requirements may be used in the method of FIG. 7 as will occur to those of skill in the art.

Determining (726) whether the technically feasible updated service model (722) meets predetermined SOA compliance requirements (724) may be carried out by one or more business members, one or more business consultants, one or more subject matter experts, one or more governance software applications using web servers, spreadsheets, databases, computers, networks, aggregations of software and hardware, and other tools as will occur to those of skill in the art.

If the updated service model does not meet predetermined SOA compliance requirements the method of FIG. 7 includes reallocating services in the preliminary service model to service components or reallocating service components to service layers in the preliminary SOA service architecture. Reallocating (708) services in the preliminary service model to service components may be carried out by again allocating (708) services in the preliminary service model to service components as described above using the decision of feasibility to change the allocation. Reallocating (712) service components to service layers in the preliminary SOA service architecture may be carried out by again allocating (712) service components to service layers in the preliminary SOA service architecture as described above using the decision of feasibility to change the allocation.

Reallocating services in the preliminary service model to service components or reallocating service components to service layers in the preliminary SOA service architecture may be carried out by one or more business members, one or more business consultants, one or more subject matter experts, one or more governance software applications using web servers, spreadsheets, databases, computers, networks, aggregations of software and hardware, and other tools as will occur to those of skill in the art.

If the updated service model (722) meets predetermined SOA compliance requirements, The method of FIG. 7 also includes communicating (728) the SOA compliant updated service model (722) to relevant stakeholders in the SOA. Communicating (728) the SOA compliant updated service model (722) to relevant stakeholders in the SOA may be carried out by one or more business members, one or more business consultants, one or more subject matter experts, one or more governance software applications using web servers, spreadsheets, databases, computers, networks, aggregations of software and hardware, and other tools as will occur to those of skill in the art.

### Governing the Design of Services in an SOA

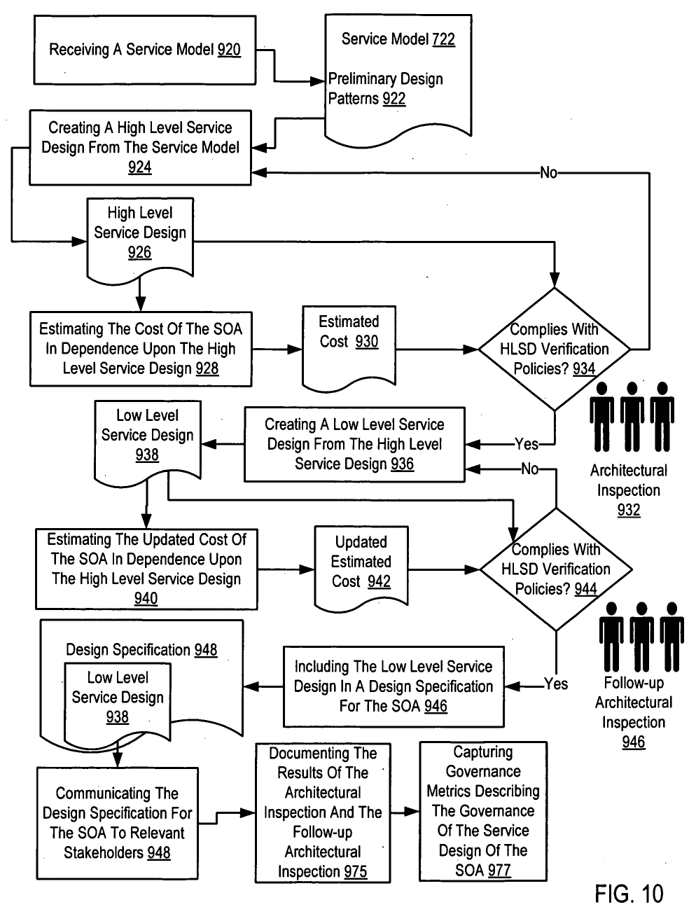

For further explanation, FIG. 10 sets forth a flow chart illustrating an exemplary method of governing the design of services in a Service Oriented Architecture (‘SOA’) according to exemplary embodiments of the present invention. The method of FIG. 10 includes receiving (920) a service model (722), the service model having preliminary design patterns (922) that include preliminary service components allocated to preliminary service layers of the SOA service architecture. The method of realizing services described above with reference to FIG. 7 results in a service model having preliminary service components allocated to preliminary service layers of the SOA service architecture. Such preliminary service components allocated to preliminary service layers of the SOA service architecture are included in design patterns that may also include other information such as standards available and used in the components allocated to service layers, how legacy system functionality may be leveraged using the components allocated to particular service layers, the type of adapters that may be required to wrap the legacy systems of components allocated to service layers, and other information as will occur to those of skill in the art.

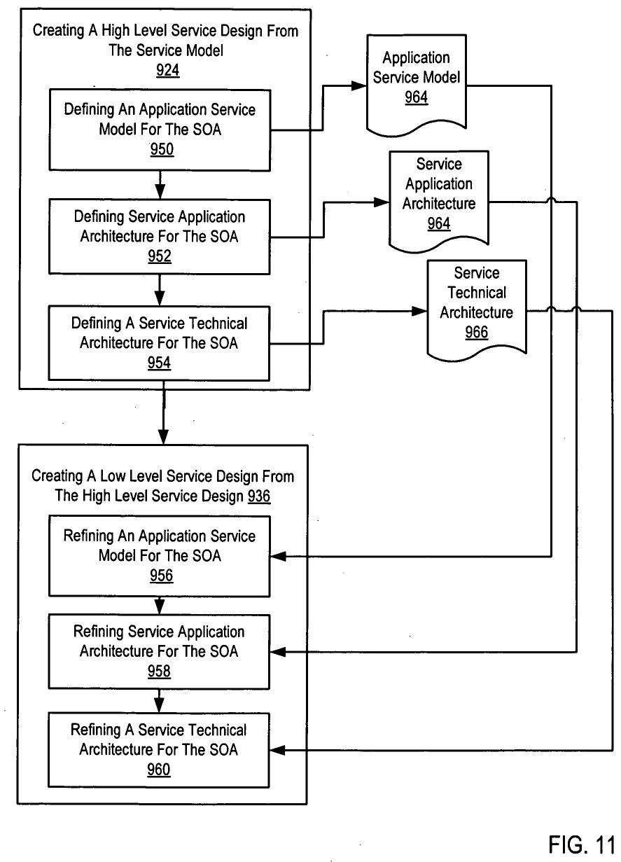

The method of FIG. 10 includes creating (924) a high level service design (926) from the service model (722). A high level service design provides a more granular service design than that provided in the received service model having the preliminary service components allocated to preliminary service layers of the SOA service architecture. Such a high level service design begins to more particularly select and design the particular services for the service components allocated to the preliminary service layers of the SOA. Creating (924) a high level service design (926) from the service model (722) according to the method of FIG. 10 may be carried out by defining an application service model for the SOA, defining a service application architecture for the SOA, and defining a service technical architecture for the SOA as described below with reference to FIG. 11. Creating (924) a high level service design (926) from the service model (722) according to the method of FIG. 10 may be carried out by one or more business members, one or more business consultants, one or more subject matter experts, one or more governance software applications using web servers, spreadsheets, databases, computers, networks, aggregations of software and hardware, and other tools as will occur to those of skill in the art.

The method of FIG. 10 includes estimating (928) the cost (930) of the SOA in dependence upon the high level service design (926). Estimating (928) the cost (930) of the SOA in dependence upon the high level service design (926) includes evaluating the high level design and predicting a funding estimate required to implement an SOA conforming to that high level service design. Estimating (928) the cost (930) of the SOA in dependence upon the high level service design (926) is typically performed after enough is known about the scope of the high level service design to reasonably predict a rough estimate for initial funding of the SOA. The variance allowed in estimating the SOA will vary from organization to organization depending on many factors such as management directives, available budgets and many others as will occur to those of skill in the art.

Estimating (928) the cost (930) of the SOA in dependence upon the high level service design (926) may be carried out by one or more business members, one or more business consultants, one or more subject matter experts, one or more governance software applications using web servers, spreadsheets, databases, computers, networks, aggregations of software and hardware, and other tools as will occur to those of skill in the art.

The method of FIG. 10 includes determining (934), during an architectural inspection (932), whether the high level service design (926) and the estimated cost (930) of the SOA complies with predetermined high-level service design verification policies. An architectural inspection is an evaluation of the high level service design from a technical perspective, a business perspective, and a cost perspective. An architectural inspection (932) is typically carried out by an architectural review board including business solution architects and technical application solution architects. Although only a single architectural inspection is illustrated in the example of FIG. 10, such architectural inspections may be carried out on a recurring basis and the results of such inspections may be published.

Predetermined high-level service design verification policies are rules governing both the high level service design and the cost. Predetermined high-level service design verification policies according to the method of FIG. 10 may include policies requiring the services to be compliant with the existing reference architecture, policies requiring the services to comply with critical infrastructure protection (‘CIP’) policies for the SOA such as security management policies and others, policies governing the funding requirements of the SOA such as total estimated cost or allocations of costs over time, and other polices as will occur to those of skill in the art.

Determining (934), during an architectural inspection (932), whether the high level service design (926) and the estimated cost (930) of the SOA complies with predetermined high-level service design verification policies may be carried out by one or more business members, one or more business consultants, one or more subject matter experts, one or more governance software applications using web servers, spreadsheets, databases, computers, networks, aggregations of software and hardware, and other tools as will occur to those of skill in the art.

If the high level service design and the estimated cost of the SOA does not comply with predetermined service design verification policies, the method of FIG. 10 includes creating a refined high level service design. Creating a refined high level service design according to the method of FIG. 10 may be carried out by again creating a high level service design from the service model using the high level service design verification policies and results from the architectural inspection as additional inputs.

If the high level service design (926) and the estimated cost (930) of the SOA complies with predetermined service design verification policies, the method of FIG. 10 includes creating (936) a low level service design (938) from the high level service design (926). Creating (936) a low level service design from the high level service design may be carried out by refining the application service model for the SOA, refining the service application architecture for the SOA, and refining the service technical architecture for the SOA as described below with reference to FIG. 11.

Creating (936) a low level service design from the high level service design by refining the application service model for the SOA, refining the service application architecture for the SOA, and refining the service technical architecture for the SOA may result in some embodiments of the present invention in a low level service design that includes an operational model, a web services definition language service contract, a design interaction diagram, a design class diagram, and interface contract, a component model, and a documentation of the architectural decisions made for the SOA. An operational model describes the functional model of the SOA. A web services definition language service contract defines a communications agreement implemented in web services definition language. A design interaction diagram illustrates the interaction of services in the SOA. A design class diagram is a diagram illustrating the relationship among the classes of the SOA. An interface contract defines the interfaces used to communicate among the service layers of the SOA. A component model defines the interaction of service components in the SOA. Documentation of the architectural decisions made for the SOA defines the technical architectural decisions made in designing the low level service design.

Creating (936) a low level service design from the high level service design may be carried out by one or more business members, one or more business consultants, one or more subject matter experts, one or more governance software applications using web servers, spreadsheets, databases, computers, networks, aggregations of software and hardware, and other tools as will occur to those of skill in the art.

The method of FIG. 10 includes estimating (940) an updated cost (942) of the SOA in dependence upon the low level service design (938). Estimating (940) an updated cost (942) of the SOA in dependence upon the low level service design (938) includes evaluating the low level design and predicting a funding estimate required to implement an SOA conforming to that low level service design. Estimating (940) an updated cost (942) of the SOA in dependence upon the low level service design (938) is typically performed after enough is known about the scope of the low level service design to reasonably predict an estimate for the total funding of the SOA. The variance allowed in estimating the cost of the SOA will vary from organization to organization depending on many factors such as management directives, available budgets and many others as will occur to those of skill in the art.

Estimating (940) an updated cost (942) of the SOA in dependence upon the low level service design (938) may be carried out by one or more business members, one or more business consultants, one or more subject matter experts, one or more governance software applications using web servers, spreadsheets, databases, computers, networks, aggregations of software and hardware, and other tools as will occur to those of skill in the art.

The method of FIG. 10 includes determining (944), during a follow-up architectural inspection (946), whether the low level service design (938) and the estimated updated cost (942) of the SOA complies with predetermined low-level service design verification policies. A follow-up architectural inspection is an evaluation of the low level service design from a technical perspective, a business perspective, and a cost perspective. A follow-up architectural inspection is typically carried out by an architectural review board including business solution architects and technical application solution architects. Although only a single follow-up architectural inspection is illustrated in the example of FIG. 10, such architectural inspections may be carried out on a recurring basis and the results of such inspections may be published.

Predetermined low-level service design verification policies are rules governing both the low level service design and the updated cost of that SOA design. Predetermined low-level service design verification policies according to the method of FIG. 10 may include more rigidly defined policies than the high level service design verification policies described above.

Determining (944), during a follow-up architectural inspection (946), whether the low level service design (938) and the estimated updated cost (942) of the SOA complies with predetermined low-level service design verification policies may be carried out by one or more business members, one or more business consultants, one or more subject matter experts, one or more governance software applications using web servers, spreadsheets, databases, computers, networks, aggregations of software and hardware, and other tools as will occur to those of skill in the art.

If the low level service design and the estimated updated cost of the SOA does not comply with the predetermined low-level service design verification policies, the method of FIG. 10 includes creating a refined low level service design. Creating a refined low level service design according to the method of FIG. 10 may be carried out by again creating a low level service design from the high level service design using the low level service design verification policies and results from the architectural inspection as additional inputs.

If the low level service design (938) and the estimated updated cost (942) of the SOA complies with predetermined low-level service design verification policies, the method of FIG. 10 includes incorporating (946) the low level service design (938) in a design specification (948) for the SOA. A design specification documents the current state of the SOA design. Incorporating (946) the low level service design (938) in a design specification (948) for the SOA may be carried out by one or more business members, one or more business consultants, one or more subject matter experts, one or more governance software applications using web servers, spreadsheets, databases, computers, networks, aggregations of software and hardware, and other tools as will occur to those of skill in the art.

The method of FIG. 10 includes communicating (948) the design specification (948) for the SOA to relevant stakeholders (106) in the SOA. Communicating (948) the design specification (948) for the SOA to relevant stakeholders (106) in the SOA may be carried out by one or more business members, one or more business consultants, one or more subject matter experts, one or more governance software applications using web servers, spreadsheets, databases, computers, networks, aggregations of software and hardware, and other tools as will occur to those of skill in the art.

The method of FIG. 10 includes documenting (975) the results of the architectural inspection and the follow-up architectural inspection. Documenting (975) the results of the architectural inspection and the follow-up architectural inspection typically includes making the results of the architectural inspection and follow-up architectural inspection available to interested parties. Such information may be useful in refining high level service designs and low level service designs as will occur to those of skill in the art. Documenting (975) the results of the architectural inspection and the follow-up architectural inspection may be carried out by one or more members of an architectural review board, one or more governance software applications using web servers, spreadsheets, databases, computers, networks, aggregations of software and hardware, and other tools as will occur to those of skill in the art.

The method of FIG. 10 includes capturing (977) governance metrics describing the governance of the service design of the SOA. Governance metrics include data describing performance of aspects of service design governed according to embodiments of the present invention. Governance metrics may include surveys of business members involved in carrying out service design governed according to embodiments of the present invention, data recorded by computer systems identifying statistics describing service design, such as the amount of time required to perform an architectural inspection, or the number of parties involved in the architectural inspection and so on as will occur to those of skill in the art. Capturing (977) governance metrics describing the governance of the service design of the SOA may be carried out by one or more business members, one or more business consultants, one or more subject matter experts, one or more governance software applications using web servers, spreadsheets, databases, computers, networks, aggregations of software and hardware, and other tools as will occur to those of skill in the art.

As mentioned above, the method of FIG. 10 includes creating a high level service design from the service model and creating a low level service design from the high level service design. For further explanation, FIG. 11 sets forth a flow chart illustrating exemplary methods of creating a high level service design from the service model and creating a low level service design from the high level service design.

Creating a high level service design from the service model according to the method of FIG. 11 includes defining (950) an application service model (964) for the SOA, defining (952) service application architecture (964) for the SOA, and defining (954) a service technical architecture (966) for the SOA. An application service model includes conceptual representations of the solution to be delivered in the SOA. Defining (950) an application service model (964) for the SOA may be carried out by describing those conceptual representations of the solution to be delivered in the SOA with both textual and graphical components. Application service model outlines the classes and their major responsibilities and collaborations for one or more key defined use cases if object oriented techniques. Class diagrams are used to determine the level of detail required to establish a reasonable level of understanding of the SOA with analysts, SOA designers and others. The application service model may include an updated component model, design class diagrams and design interaction diagrams and updated architectural decisions. It may also define a Service Interface Contract.

Defining (952) service application architecture (964) for the SOA may be carried out by documenting application architecture with less detail than that contained in the low level service design. A service application architecture (964) according to the method of FIG. 11 documents the enterprise-level application functions which are implemented across the enterprise and also within a particular business area including the inter-relationships and dependencies and opportunities for standardization and sharing of components across various divisional and organizational groups. A service application architecture (964) according to embodiments of the present invention also typically includes a reminder of the overall scope, objectives, and deliverables of the project, an overview of the application principles, which will underpin all subsequent application design and package and IT acquisition decisions, a high-level application model showing the major application groups defined and their functional boundaries and the relationship between the groupings, an overview of how this application architecture forms a key component part of an overall enterprise-wide IT Architecture and feeds into subsequent IT Architecture, a summary of any key issues relating to the above application architecture components that need senior management decisions and attention, a mapping of the application groups to business goals and objectives and other information that will occur to those of skill in the art.

Defining (954) a service technical architecture (966) for the SOA may be carried out by documenting service technical architecture with less detail than that contained in the low level service design. A service technical architecture (966) identifies the necessary technology needed to implement the SOA. Such a service technical architecture may be used to select and acquire the proper technology to implement the SOA. A service technical architecture (966) according to embodiments of the present invention includes hardware and software cost estimates and a technology implementation plan.

Creating (936) a low level service design from the high level service design according to the method of FIG. 11 includes refining (956) the application service model for the SOA, refining (958) the service application architecture for the SOA, and refining (960) the service technical architecture for the SOA. Refining (956) the application service model for the SOA may be carried out by including more implementation details in the application service model (964) for the SOA in more detail than that contained in the high level service design. A refined application service model may include detailed descriptions of conceptual representations of the solution to be delivered in the SOA with more detailed text and more detailed graphical components.

Refining (958) the service application architecture for the SOA may be carried out by including more implementation details in the service application architecture. A refined service application architecture for the SOA may include implementation details of inter-relationships and dependencies of both enterprise-wide SOA functionality as well as business area specific functionality.

Refining (960) the service technical architecture for the SOA may be carried out by including more implementation details in the service technical architecture. A refined service technical architecture for the SOA may include additional implementation detail of the hardware and software cost estimates and a more detailed technology implementation plan.

Creating a high level service design from the service model and creating a low level service design from the high level service design according to the method of FIG. 11 typically results in a low level service design that includes an operational model, a web services definition language service contract, a design interaction diagram, a design class diagram, and interface contract, a component model, and a documentation of the architectural decisions made for the SOA.

Exemplary embodiments of the present invention are described largely in the context of methods for governing the design for services in a Service Oriented Architecture (‘SOA’). Readers of skill in the art will recognize, however, that some or all aspects or embodiments of the present invention also may be embodied in systems including one or more computer program products disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention.

Exemplary embodiments of the present invention described largely in the context of methods for governing the design of services in a Service Oriented Architecture (‘SOA’) may also be implemented as services. Such services may be carried out in conducting business by a service provider for one or more clients as will occur to those of skill in the art.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of governing the design of services in a Service Oriented Architecture (‘SOA’), the method
receiving a service model, the service model having preliminary design patterns that include preliminary service components allocated to preliminary service layers of the SOA service architecture;
creating a high level service design from the service model;
estimating the cost of the SOA in dependence upon the high level service design;
determining, during an architectural inspection, whether the high level service design and the estimated cost of the SOA complies with predetermined high-level service design verification policies;
if the high level service design and the estimated cost of the SOA complies with predetermined service design verification policies, creating a low level service design from the high level service design;
estimating an updated cost of the SOA in dependence upon the low level service design;
determining, during a follow-up architectural inspection, whether the low level service design and the estimated updated cost of the SOA complies with predetermined low-level service design verification policies; and
if the low level service design and the estimated updated cost of the SOA complies with predetermined low-level service design verification policies, incorporating the low level service design in a design specification for the SOA.

2. The method of claim 1 further comprising communicating the design specification for the SOA to relevant stakeholders in the SOA.

3. The method of claim 1 further comprising creating a refined high level service design if the high level service design and the estimated cost of the SOA does not comply with predetermined service design verification policies.

4. The method of claim 1 further comprising creating a refined low level service design if the low level service design and the estimated updated cost of the SOA does not comply with the predetermined low-level service design verification policies.

5. The method of claim 1 wherein creating a high level service design from the service model further comprises:
defining an application service model for the SOA;
defining service application architecture for the SOA; and
defining a service technical architecture for the SOA.

6. The method of claim 4 wherein creating a low level service design from the high level service design further comprises:
refining the application service model for the SOA;
refining the service application architecture for the SOA; and
refining the service technical architecture for the SOA.

7. The method of claim 1 wherein the low level service design further comprises an operational model, a web services definition language service contract, a design interaction diagram, a design class diagram, and interface contract, a component model, and a documentation of the architectural decisions made for the SOA.

8. The method of claim 1 further comprising documenting the results of the architectural inspection and the follow-up architectural inspection.

9. The method of claim 1 further comprising capturing governance metrics describing the governance of the service design of the SOA.

10. A service for governing the design of services in a Service Oriented Architecture (‘SOA’), the service comprising:
creating a high level service design from a service model;
determining, during an architectural inspection, whether the high level service design and an estimated cost of the SOA complies with predetermined high-level service design verification policies;
if the high level service design and the estimated cost of the SOA complies with predetermined service design verification policies, creating a low level service design from the high level service design;
determining, during a follow-up architectural inspection, whether the low level service design and an estimated updated cost of the SOA complies with predetermined low-level service design verification policies; and
if the low level service design and the estimated updated cost of the SOA complies with predetermined low-level service design verification policies, incorporating the low level service design in a design specification for the SOA.

11. A system of governing the design of services in a Service Oriented Architecture (‘SOA’), the system comprising:
means for receiving a service model, the service model having preliminary design patterns that include preliminary service components allocated to preliminary service layers of the SOA service architecture;
means for creating a high level service design from the service model;
means for estimating the cost of the SOA in dependence upon the high level service design;
means for determining, during an architectural inspection, whether the high level service design and the estimated cost of the SOA complies with predetermined high-level service design verification policies;
if the high level service design and the estimated cost of the SOA complies with predetermined service design verification policies, means for creating a low level service design from the high level service design;
means for estimating an updated cost of the SOA in dependence upon the low level service design;
means for determining, during a follow-up architectural inspection, whether the low level service design and the estimated updated cost of the SOA complies with predetermined low-level service design verification policies; and
if the low level service design and the estimated updated cost of the SOA complies with predetermined low-level service design verification policies, means for incorporating the low level service design in a design specification for the SOA.

12. The system of claim 11 further comprising means for communicating the design specification for the SOA to relevant stakeholders in the SOA.

13. The system of claim 11 further comprising means for creating a refined high level service design if the high level service design and the estimated cost of the SOA does not comply with predetermined service design verification policies.

14. The system of claim 11 further comprising means for creating a refined low level service design if the low level service design and the estimated updated cost of the SOA does not comply with the predetermined low-level service design verification policies.

15. The system of claim 11 wherein means for creating a high level service design from the service model further comprises:
means for defining an application service model for the SOA;
means for defining service application architecture for the SOA; and
means for defining a service technical architecture for the SOA.

16. The system of claim 15 wherein means for creating a low level service design from the high level service design further comprises:
means for refining the application service model for the SOA;
means for refining the service application architecture for the SOA; and
means for refining the service technical architecture for the SOA.

17. The system of claim 11 wherein the low level service design further comprises an operational model, a web services definition language service contract, a design interaction diagram, a design class diagram, and interface contract, a component model, and a documentation of the architectural decisions made for the SOA.

18. The system of claim 11 further comprising means for documenting the results of the architectural inspection and the follow-up architectural inspection.

19. The system of claim 11 further comprising means for capturing governance metrics describing the governance of the service design of the SOA.
